(19) United States
(12) Patent Application Publication
(10) Pub. No.: US 2026/0184855 A1
(43) Pub. Date: Jul. 2, 2026

(54) POLYSILSESQUIOXANE LIQUID PRECURSOR, CURED OBJECT, AND PRODUCTION METHODS THEREFOR

(71) Applicants: AGC Inc., Tokyo (JP); TOKYO METROPOLITAN PUBLIC UNIVERSITY CORPORATION, Tokyo (JP)

(72) Inventors: Satoshi YOSHIDA, Tokyo (JP); Akio KOIKE, Tokyo (JP); Tetsuya NAKASHIMA, Tokyo (JP); Koichi KAJIHARA, Tokyo (JP); Takuma YOSHIDA, Tokyo (JP)

(73) Assignees: AGC Inc., Tokyo (JP); TOKYO METROPOLITAN PUBLIC UNIVERSITY CORPORATION, Tokyo (JP)

(21) Appl. No.: 19/549,114

(22) Filed: Feb. 25, 2026

Related U.S. Application Data
(63) Continuation of application No. PCT/JP2024/029412, filed on Aug. 20, 2024.

(30) Foreign Application Priority Data
Aug. 28, 2023 (JP) 2023-138037

(51) Int. Cl. C08G 77/18; C08G 77/06; C08G 77/16

(52) U.S. Cl. CPC C08G 77/18; C08G 77/06; C08G 77/16

(57) ABSTRACT

A polysilsesquioxane liquid precursor includes a copolymer of a trifunctional silicon alkoxide and a difunctional silicon alkoxide, and residual silanol group fraction f_{SiOH} in the copolymer is 0.02 to 0.3. A method for producing a polysilsesquioxane liquid precursor includes subjecting a trifunctional silicon alkoxide and a difunctional silicon alkoxide to a hydrolysis reaction and a polycondensation reaction in an aqueous solution without using an organic solvent in the presence of an acid catalyst, with aging during the hydrolysis reaction and the polycondensation reaction.

### CROSS-REFERENCE TO RELATED APPLICATIONS

This is a bypass continuation of International Application No. PCT/JP2024/029412 filed on Aug. 20, 2024, and claims priority from Japanese Patent Application No. 2023-138037 filed on Aug. 28, 2023, the entire content of which is incorporated herein by reference.

### TECHNICAL FIELD

The present invention relates to a polysilsesquioxane liquid precursor, a cured body, and production methods thereof.

### BACKGROUND ART

A silicon-based organic-inorganic hybrid material contains silicon (Si) as a network element. Silicon (Si) has four bonds and exhibits various properties depending on atoms and functional groups to be bonded. The oxygen (O) and the carbon (C) are strongly bonded to Si. Oxygen bridges Si atoms by forming Si—O—Si bonds, thereby forming a polymer. On the other hand, carbon has an effect of suppressing Si—O—Si bond formation. Such a silicon-based organic-inorganic hybrid material is excellent in heat resistance, chemical durability, transparency, electrical insulation, and the like, and thus is used as an optical material or an electronic material.

Polysilsesquioxane is composed of a silsesquioxane network represented by a general formula RSiO_{3/2} (R represents an organic functional group) having one Si—C bond and three Si—O bonds per Si atom. The polysilsesquioxane exhibits a random structure, a ladder structure, a cage structure, and the like, and has excellent mechanical strength and chemical and thermal durability.

The polysilsesquioxane is obtained by hydrolyzing and polycondensing trifunctional silicon alkoxides. In order to synthesize the polysilsesquioxane, various synthesis methods have been studied in the related art.

For example, Patent Literature 1 proposes a method for producing a polysilsesquioxane liquid. The method includes hydrolyzing and polycondensing a mixture of a trifunctional silicon alkoxide, water, and an acid catalyst without using an organic solvent, and then removing an alcohol generated by hydrolysis of the trifunctional silicon alkoxide. Patent Literature 2 discloses that polymethylsilsesquioxane having a weight average molecular weight (Mw₁) in terms of polystyrene within a range of 2000 to 20000 and containing 65 mol % or more of a silicon-containing bonding unit T³₁ (here, T³₁ is a silicon-containing bonding unit in which all three oxygen atoms bonded to a silicon atom are bonded to other silicon atoms) is produced by condensing an oligomer having a weight average molecular weight (Mw₂) in terms of polystyrene of 600 to 2000 and in which Mw₂ and a silicon-containing bonding unit T³₂ satisfy a relationship of Formula (1): T³₂≥0.026×Mw₂+20, at a concentration of 5 mass % to 40 mass % in the presence of an acidic catalyst or in the absence of a catalyst.
Patent Literature 1: JP2013-253223A
Patent Literature 2: JP2018-178011A

### SUMMARY OF INVENTION

The properties of conventionally known polysilsesquioxanes do not yet provide sufficiently satisfactory performance, and further improvements and developments are desired. When a liquid precursor of polysilsesquioxane is thermally cured without using an additive, a curing catalyst, or the like, it has been difficult to produce a thick cured body by a production method according to the related art, and a cured body having a thickness of 5 mm or more has been difficult to obtain.

Therefore, an object of the present invention is to provide a method for producing a thick polysilsesquioxane cured body having high hardness and excellent transparency without using an additive, a curing catalyst, or the like, and to provide a polysilsesquioxane liquid precursor for obtaining such a cured body, and a cured body.

One aspect of the present invention relates to a polysilsesquioxane liquid precursor containing a copolymer of a trifunctional silicon alkoxide and a difunctional silicon alkoxide, in which a residual silanol group fraction f_{SiOH} in the copolymer is 0.02 to 0.3.

Another aspect of the present invention relates to a cured body of a copolymer of a trifunctional silicon alkoxide and a difunctional silicon alkoxide, in which a residual silanol group fraction f_{SiOH} in the copolymer is 0.02 to 0.3.

Still another aspect of the present invention relates to a method for producing a polysilsesquioxane liquid precursor. The method includes subjecting a trifunctional silicon alkoxide and a difunctional silicon alkoxide to a hydrolysis reaction and a polycondensation reaction in an aqueous solution without using an organic solvent in the presence of an acid catalyst, with aging during the hydrolysis reaction and the polycondensation reaction.

Still another aspect of the present invention relates to a method for producing a cured body. The method includes heating and curing the polysilsesquioxane liquid precursor obtained by the above method for producing a polysilsesquioxane liquid precursor.

With the polysilsesquioxane liquid precursor obtained according to the method for producing a polysilsesquioxane liquid precursor of the present invention, a cured body having high hardness and excellent transparency can be obtained. Therefore, the cured body is expected to be used in various electronic applications as an ultraviolet transparent material, a transparent adhesive, a sealing material, an insulating film, and a scratch resistant material.

### BRIEF DESCRIPTION OF DRAWINGS

FIGS. 1A to 1J are photographs showing appearances of liquid precursors produced in Test Example 1. FIGS. 1A to 1J are photographs showing the appearances of the liquid precursors of Examples 1 to 10, respectively.

FIGS. 2A to 2I are photographs showing appearances of liquid precursors produced in Test Example 2. FIGS. 2A to 2I are photographs showing the appearances of the liquid precursors of Examples 11 to 19, respectively.

FIGS. 3A and 3B are graphs showing change of viscosity of liquid precursors performed in Test Example 3. FIGS. 3A and 3B are graphs showing viscosity changes of the liquid precursors of Examples 12 to 14 and Examples 17 to 19, respectively.

FIGS. 4A to 4E are photographs showing appearances of liquid precursors produced in Test Example 4. FIGS. 4A to 4E are photographs showing the appearances of the liquid precursors of Examples 20 to 24, respectively.

FIGS. 5A and 5B are photographs showing appearances of cured bodies produced in Test Example 5. FIGS. 5A and 5B are photographs showing the appearances of the cured bodies of Examples 25 and 26, respectively.

FIGS. 6A and 6B are photographs showing an appearance of a cured body in Example 27 produced in Test Example 5. FIG. 6A is a top view, and FIG. 6B is a side view.

FIGS. 7A to 7D are photographs showing appearances of cured bodies produced in Test Example 5. FIGS. 7A to 7D are photographs showing the appearances of the cured bodies of Examples 28 to 31, respectively.

FIG. 8 is a graph showing a stress-strain curve recorded in an uniaxial loading-unloading test in Test Example 6.

### DESCRIPTION OF EMBODIMENTS

Hereinafter, the present invention will be described, and the present invention is not limited by examples in the following description.

### (Polysilsesquioxane Liquid Precursor)

The polysilsesquioxane liquid precursor according to the present invention contains a copolymer of a trifunctional silicon alkoxide and a difunctional silicon alkoxide, and the residual silanol group fraction f_{SiOH} in the copolymer is 0.02 to 0.3.

According to the polysilsesquioxane liquid precursor having such characteristics, a cured body having elasticity and also having high hardness can be obtained. In addition, the polysilsesquioxane liquid precursor of the present invention can maintain a liquid state for a long period of time without gelation during storage at room temperature.

The trifunctional silicon alkoxide is a compound in which three of four bonds of silicon (Si) are bonded to alkoxy groups.

Examples of the trifunctional silicon alkoxide include trimethoxysilane, ethyltrimethoxysilane, propyltrimethoxysilane, methyltrimethoxysilane, phenyltrimethoxysilane, 3-mercaptopropyltrimethoxysilane, vinyltrimethoxysilane, 3-glycidoxypropyltrimethoxysilane, 3-aminopropyltrimethoxysilane, triethoxysilane, methyltriethoxysilane, ethyltriethoxysilane, propyltriethoxysilane, phenyltriethoxysilane, 3-mercaptopropyltriethoxysilane, vinyltriethoxysilane, 3-glycidoxypropyltriethoxysilane, and 3-aminopropyltriethoxysilane. The trifunctional silicon alkoxide may contain one kind of these alone, or may contain two or more kinds thereof in combination.

Among them, the trifunctional silicon alkoxide is preferably at least one selected from methyltrimethoxysilane, methyltriethoxysilane, ethyltrimethoxysilane, and ethyltriethoxysilane, and more preferably methyltrimethoxysilane. The trifunctional silicon alkoxide contains still more preferably 80 mol % or more of methyltrimethoxysilane, and particularly preferably 95 mol % or more of methyltrimethoxysilane, based on the total mol % of the trifunctional silicon alkoxide.

The difunctional silicon alkoxide is a compound in which two of four bonds of silicon are bonded to alkoxy groups.

Examples of the difunctional silicon alkoxide include dimethoxysilane, dimethoxymethylsilane, dimethoxydimethylsilane, dimethoxyethylsilane, dimethoxydiethylsilane, dimethoxyethylmethylsilane, dimethoxyphenylsilane, dimethoxymethylphenylsilane, dimethoxydiphenylsilane, dimethoxyvinylsilane, dimethoxymethylvinylsilane, dimethoxydivinylsilane, diethoxysilane, diethoxymethylsilane, diethoxydimethylsilane, diethoxyethylsilane, diethoxydiethylsilane, diethoxyethylmethylsilane, diethoxyphenylsilane, diethoxymethylphenylsilane, diethoxydiphenylsilane, diethoxyvinylsilane, diethoxymethylvinylsilane, and diethoxydivinylsilane. The difunctional silicon may contain one kind of these alone, or may contain two or more kinds thereof in combination.

Among them, the difunctional silicon alkoxide is preferably at least one selected from dimethoxydimethylsilane, dimethoxyethylmethylsilane, dimethoxydiethylsilane, diethoxydimethylsilane, diethoxyethylmethylsilane, and diethoxydiethylsilane, and more preferably dimethoxydimethylsilane. The difunctional silicon alkoxide contains still more preferably 80 mol % or more of dimethoxydimethylsilane, and particularly preferably 95 mol % or more of dimethoxydimethylsilane, based on the total mol % of the difunctional silicon alkoxide.

In the present description, a structural unit derived from a trifunctional silicon alkoxide in the copolymer is referred to as a “T unit”, and the T unit is classified into three types according to the number of bridging oxygen atoms bonded to other silicon atoms. When all oxygen atoms of the three oxygen atoms are bonded to other silicon atoms, that is, when the number of bridging oxygen atoms is three, the structural unit is referred to as “T³ unit”. When two oxygen atoms of the three oxygen atoms are bonded to other silicon atoms, that is, when the number of bridging oxygen atoms is two, the structural unit is referred to as “T² unit”. When one oxygen atom of the three oxygen atoms is bonded to another silicon atom, that is, when the number of bridging oxygen atoms is one, the structural unit is referred to as “T¹ unit”.

A structural unit derived from a difunctional silicon alkoxide in the copolymer is referred to as a “D unit”, and the D unit is classified into two types according to the number of bridging oxygen atoms bonded to other silicon atoms. When both oxygen atoms of the two oxygen atoms are bonded to other silicon atoms, that is, when the number of bridging oxygen atoms is two, the structural unit is referred to as “D² unit”, and when one oxygen atom of the two oxygen atoms is bonded to another silicon atom, that is, when the number of bridging oxygen atoms is one, the structural unit is referred to as “D¹ unit”.

In the polysilsesquioxane liquid precursor of the present embodiment, a proportion of bridging oxygen atoms in the copolymer is determined by the following formula (1).

$$Proportion of bridging oxygen atoms = < m > / < m {>}_{max} \qquad ( 1 )$$

In the formula (1),
<m>ₘₐₓ represents the maximum average number of bridging oxygen atoms in the complete copolymer when all the structural units in the structural units derived from the trifunctional silicon alkoxide are T³ structural units having three crosslinked oxygen atoms, and all the structural units in the structural units derived from the difunctional silicon alkoxide are D² structural units having two bridging oxygen atoms, and
<m> represents the average number of bridging oxygen atoms actually contained in the copolymer represented by the following formula (2).

$$< m > = ( {f}_{T 1} \times {n}_{T 1} ) + ( {f}_{T 2} \times {n}_{T 2} ) + ( {f}_{T 3} \times {n}_{T 3} ) + ( {f}_{D 1} \times {n}_{D 1} ) + ( {f}_{D 2} \times {n}_{D 2} ) \qquad ( 2 )$$

In the formula (2),
f_{T1} represents a fraction of a T¹ structural unit having one bridging oxygen atom among the structural units derived from the trifunctional silicon alkoxide,
n_{T1} represents 1, which is the number of bridging oxygen atoms in the T¹ structural unit,
f_{T2} represents a fraction of a T² structural unit having two bridging oxygen among the structural units derived from the trifunctional silicon alkoxide,
n_{T2} represents 2, which is the number of bridging oxygen atoms in the T² structural unit,
f_{T3} represents a fraction of a T³ structural unit having three bridging oxygen atoms among the structural units derived from the trifunctional silicon alkoxide,
n_{T3} represents 3, which is the number of bridging oxygen atoms in the T³ structural unit,
f_{D1} represents a fraction of a D¹ structural unit having one bridging oxygen atom among the structural units derived from the difunctional silicon alkoxide,
n_{D1} represents 1, which is the number of bridging oxygen atoms in the D¹ structural unit,
f_{D2} represents a fraction of a D² structural unit having two bridging oxygen atoms among the structural units derived from the difunctional silicon alkoxide,
n_{D2} represents 2, which is the number of bridging oxygen atoms in the D² structural unit, and
f_{T1}, f_{T2}, f_{T3}, f_{D1} and f_{D2} have the following relationships.

$${f}_{T 1} + {f}_{T 2} + {f}_{T 3} + {f}_{D 1} + {f}_{D 2} = 1$$

The fraction f_{T1} of the T¹ structural units, the fraction f_{T2} of the T² structural units, the fraction f_{T3} of the T³ structural units, the fraction f_{D1} of the D¹ structural units, and the fraction f_{D2} of the D² structural units are determined by measuring a ²⁹Si NMR spectrum and calculating the respective ratios from the results.

The polysilsesquioxane liquid precursor of the present embodiment has a residual silanol group fraction f_{SiOH} of 0.02 to 0.3 in the copolymer.

The residual silanol group fraction f_{SiOH} is a ratio of the total number of SiOH groups present in the copolymer of trifunctional silicon and difunctional silicon to a product of the total number of Si atoms and <m>ₘₐₓ. When the residual silanol group fraction f_{SiOH} is 0.02 or more, curing by a polycondensation reaction during thermal curing easily proceeds, so that a cured body having high hardness is obtained. When the residual silanol group fraction f_{SiOH} is 0.3 or less, the stability of the liquid precursor can be maintained.

The residual silanol group fraction f_{SiOH} is preferably 0.03 or more, more preferably 0.05 or more, still more preferably 0.06 or more, and particularly preferably 0.1 or more, and is more preferably 0.25 or less, and still more preferably 0.2 or less.

The residual silanol group fraction f_{SiOH} is determined from the following formula (3) by determining the residual methoxy group fraction f_{SiOMe} from the ¹H NMR spectrum.

$$Residual silanol group fraction {f}_{SiOH} = 1 - ( < m > / < m {>}_{max} + {f}_{SiOMe} ) \qquad ( 3 )$$

In the formula (3), <m> represents an average number of bridging oxygen atoms actually contained in the copolymer, <m>ₘₐₓ represents the maximum average number of bridging oxygen atoms in the complete copolymer, and <m>/<m>ₘₐₓ represents a proportion of bridging oxygen atoms in the copolymer.

The polysilsesquioxane liquid precursor of the present embodiment preferably has a viscosity at 40° C. of 1×10⁶ mPa·s or less. When the viscosity is 1×10⁶ mPa·s or less, operability is excellent, defoaming and molding of the precursor become easy, and loss due to adhesion to the container can be prevented.

The viscosity is more preferably 1×10⁵ mPa·s or less, and the lower limit is not particularly limited because a lower viscosity is more preferable.

For example, the viscosity of the liquid precursor at 40° C. is measured using a commercially available viscometer (for example, the EMS viscometer “EMS-1000S” manufactured by Kyoto Electronics Manufacturing Co., Ltd.).

The polysilsesquioxane liquid precursor of the present embodiment preferably has a weight average molar mass (weight average molecular weight) Mm of 0.5×10³ g·mol⁻¹ to 50×10³ g mol⁻¹. The weight average molar mass Mm is more preferably 0.8×10³ g mol⁻¹ or more, and still more preferably 1.0×10³ g mol⁻¹ or more, and is more preferably 20×10³ g mol⁻¹ or less, still more preferably 15×10³ g mol⁻¹ or less, and particularly preferably 10×10³ g·mol⁻¹ or less.

The polysilsesquioxane liquid precursor preferably has a number average molar mass (number average molecular weight) Mn of 0.5×10³ g·mol⁻¹ to 5.0×10³ g·mol⁻¹. The number average molar mass Mn is more preferably 0.7×10³ g·mol⁻¹ or more, still more preferably 0.8×10³ g mol⁻¹ or more, and more preferably 4.0×10³ g mol⁻¹ or less, and still more preferably 3.0×10³ g mol⁻¹ or less.

The weight average molar mass Mm and the number average molar mass Mn are determined according to a known measurement method such as gel permeation chromatography.

### (Cured Body)

The cured body of the present invention is a cured body of a copolymer of a trifunctional silicon alkoxide and a difunctional silicon alkoxide, and the residual silanol group fraction f_{SiOH} in the copolymer is 0.02 to 0.3. The cured body according to the present invention is a cured body of a polysilsesquioxane liquid precursor obtained by curing the above-described polysilsesquioxane liquid precursor.

The trifunctional silicon alkoxide and the difunctional silicon alkoxide used in the cured body are as described above, and preferred ones are also the same. The properties of the polysilsesquioxane liquid precursor are also as described above.

The pencil hardness of the cured body of the present embodiment is preferably HB or more. When the pencil hardness is HB or more, the cured body is hard and has excellent hardness. The pencil hardness is more preferably H or more, still more preferably 2 H or more, particularly preferably 4 H or more, and most preferably 6 H or more.

The pencil hardness is measured according to the manual scratching method in accordance with the pencil scratching test specified in the former JIS K 5400.

The Vickers hardness of the cured body measured in accordance with JIS R 1610-2003 is preferably 1 HV or higher. It can be seen that when the Vickers hardness is 1 HV or higher, the cured body has high hardness while having elasticity.

The Vickers hardness is more preferably 2 HV or higher, and still more preferably 4 HV or higher.

The cured body of the present embodiment exhibits a remarkable elastic recovery behavior as shown in a uniaxial loading-unloading test in Examples described below. Accordingly, in some cases, no indentation is formed on the cured body in the Vickers hardness test, and the Vickers hardness cannot be measured. When the indentation is formed by a Vickers indenter, it can be said that the cured body has sufficient hardness. However, when the Vickers hardness cannot be measured, the hardness may be measured by a pencil hardness test.

The cured body of the present embodiment has high transparency. The cured body preferably has an ultraviolet absorption edge wavelength of 250 nm or less. When the ultraviolet absorption edge wavelength is 250 nm or less, excellent visible-ultraviolet transmittance is exhibited, and thus, high ultraviolet resistance can be expected.

The ultraviolet absorption edge wavelength is more preferably 220 nm or less, still more preferably 210 nm or less, and particularly more preferably 200 nm or less.

The ultraviolet absorption edge wavelength is a value obtained as an intersection point between an approximate straight line of a spectrum in an ultraviolet absorption edge region and an approximate straight line of a baseline spectrum in a transparent region on a long wavelength side, in a light absorption spectrum measured by a spectrophotometer (U-4100 manufactured by Hitachi High-Technologies Corporation).

The thickness of the cured body of the present embodiment can be 4.8 mm or more, preferably 5 mm or more, more preferably 8 mm or more, and still more preferably 10 mm or more. In particular, when the thickness of the cured body is 10 mm or more, the cured body can be used as a bulk material or applied to a large member.

### (Production Method)

The polysilsesquioxane liquid precursor is obtained by subjecting a trifunctional silicon alkoxide and a difunctional silicon alkoxide to a hydrolysis reaction and a polycondensation reaction in an aqueous solution without using an organic solvent in the presence of an acid catalyst, with aging during the hydrolysis reaction and the polycondensation reaction.

The trifunctional silicon alkoxide and the difunctional silicon alkoxide to which the production method of the present invention can be applied are as described above, and preferred ones are also the same.

The trifunctional silicon alkoxide is preferably used within a range of 0.5 mol to 0.99 mol based on 1 mol of the total silicon alkoxides. When the amount of the trifunctional silicon alkoxide used is within the above range, the resulting cured body has a high hardness while having an elasticity.

The amount of the trifunctional silicon alkoxide used is more preferably 0.6 mol or more, still more preferably 0.7 mol or more, and more preferably 0.95 mol or less, and still more preferably 0.9 mol or less, based on 1 mol of the total silicon alkoxides.

The difunctional silicon alkoxide is preferably used within a range of 0.01 mol to 0.5 mol based on 1 mol of the total silicon alkoxides. When the amount of the difunctional silicon alkoxide used is within the above range, the resulting cured body has high hardness while having elasticity.

The amount of the difunctional silicon alkoxide used is more preferably 0.05 mol or more, still more preferably 0.1 mol or more, and more preferably 0.4 mol or less, and still more preferably 0.3 mol or less, based on 1 mol of the total silicon alkoxides.

As the acid catalyst, nitric acid, hydrochloric acid, sulfuric acid, acetic acid, formic acid, and the like used in a sol-gel method using an organic solvent according to the related art can be preferably used, and hydrochloric acid is preferable from the viewpoint of availability, high purity, volatility, and ultraviolet transparency.

Although phosphoric acid may also be used as the acid catalyst, it is preferable not to use phosphoric acid because it has high nonvolatility and tends to remain in the copolymer.

The amount of the acid catalyst used varies depending on the type and configuration of the silicon alkoxide to be used, the type of the acid, and the like, and the acid catalyst is preferably mixed in an amount of more than 0 mol and 0.01 mol or less based on 1 mol in total of the trifunctional silicon alkoxide and the difunctional silicon alkoxide. When the amount of the acid catalyst used is 0.01 mol or less based on 1 mol in total of silicon alkoxides, a stable liquid precursor can be prepared, and the amount of acid remaining in the liquid precursor or in the cured body can also be reduced.

For example, when methyltrimethoxysilane is used as the trifunctional silicon alkoxide, and dimethoxydimethylsilane is used as the difunctional silicon alkoxide, the amount of the acid catalyst used is preferably within a range of 0.00002 mol to 0.002 mol, more preferably within a range of 0.00002 mol to 0.001 mol, based on 1 mol of the total silicon alkoxides.

In the present production method, the reaction proceeds in an aqueous solution without using an organic solvent as a solvent. Examples of water include purified water, distilled water, and ion-exchanged water.

An amount of water used varies depending on the type and configuration of the silicon alkoxide to be used, the type of acid, and the like, and water is preferably mixed within a range of 1.5 mol to 50 mol based on 1 mol in total of the trifunctional silicon alkoxide and the difunctional silicon alkoxide. When the amount of water used is 1.5 mol or more, an increase in the viscosity of the reaction solution can be prevented, and when the amount of water used is 50 mol or less, the amount of the aqueous methanol solution generated as a by-product can be prevented.

For example, when methyltrimethoxysilane is used as the trifunctional silicon alkoxide, and dimethoxydimethylsilane is used as the difunctional silicon alkoxide, the amount of water used is preferably within a range of 5 mol to 50 mol, more preferably within a range of 8 mol to 40 mol, and still more preferably within a range of 10 mol to 30 mol based on 1 mol of the total silicon alkoxides.

In the method for producing a polysilsesquioxane liquid precursor of the present embodiment, a trifunctional silicon alkoxide, a difunctional silicon alkoxide, water, and an acid catalyst are mixed, and hydrolysis and polycondensation are performed, and at that time, aging is performed by holding the mixture at a temperature of 20° C. to 100° C. for about 1 hour to 48 hours. When the reaction is performed in the above temperature range, an increase in viscosity of the obtained liquid precursor can be prevented. When the reaction is performed for a time within the above range, the reaction sufficiently proceeds, and the unreacted alkoxy group can be prevented from remaining.

Excessive water and alcohol generated during hydrolysis need to be removed. For the removal of water and alcohol, methods such as drying and liquid-liquid extraction are used. In the case of drying, drying is preferably performed at 20° C. to 100° C. for 1 hour to 48 hours. It is preferable to use vacuum drying during drying because the residual amount of water and alcohol can be reduced. In particular, in the production method of the present invention, when silicon methoxide is used as a silicon source, liquid-liquid separation into a phase rich in the polysilsesquioxane precursor and a phase rich in methanol and water occurs through hydrolysis and polycondensation. Accordingly, liquid-liquid extraction can be performed, and the drying time of the former can be shortened.

The obtained polysilsesquioxane liquid precursor is heated and cured to obtain a cured body.

The conditions of the heat treatment are not particularly limited, and the heat treatment is preferably performed at a temperature of 100° C. to 300° C. for about 1 hour to 1 week in the air or in an inert gas atmosphere such as nitrogen or in a vacuum, and more preferably in an inert gas atmosphere such as nitrogen or in a vacuum in order to improve transparency.

The heat treatment may be performed at a constant temperature or may be performed in multiple stages at different temperatures and/or times.

The polysilsesquioxane liquid precursor obtained in the present embodiment is liquid and easy to handle without gelling during storage at room temperature. The cured body obtained from the liquid precursor has high hardness while having elasticity, and exhibits excellent visible-ultraviolet transmittance. Further, the cured body of the present embodiment can be formed with a certain thickness, and therefore, a bulk body can be easily obtained.

The cured body of the present invention is suitably used for electric and electronic components as an ultraviolet transparent material, a transparent adhesive for areas where alkali is undesirable, an ultraviolet LED sealing material, an electrical insulating film, a scratch-resistant coating, an impact- and scratch-resistant cover material, and the like.

As described above, the following matters are disclosed in the present description.
<1> A polysilsesquioxane liquid precursor including a copolymer of a trifunctional silicon alkoxide and a difunctional silicon alkoxide, in which a residual silanol group fraction f_{SiOH} in the copolymer is 0.02 to 0.3.
<2> The polysilsesquioxane liquid precursor according to <1>, having a viscosity at 40° C. of 1×10⁶ mPa·s or less.
<3> The polysilsesquioxane liquid precursor according to <1> or <2>, in which the trifunctional silicon alkoxide includes 80 mol % or more of methyltrimethoxysilane based on a total mol % of the trifunctional silicon alkoxide.
<4> The polysilsesquioxane liquid precursor according to any one of <1> to <3>, in which the difunctional silicon alkoxide includes 80 mol % or more of dimethoxydimethylsilane based on a total mol % of the difunctional silicon alkoxide.
<5> A cured body of a copolymer of a trifunctional silicon alkoxide and a difunctional silicon alkoxide, in which a residual silanol group fraction f_{SiOH} in the copolymer is 0.02 to 0.3.
<6> The cured body according to <5>, in which the trifunctional silicon alkoxide includes 80 mol % or more of methyltrimethoxysilane based on a total mol % of the trifunctional silicon alkoxide.
<7> The cured body according to <5> or <6>, in which the difunctional silicon alkoxide includes 80 mol % or more of dimethoxydimethylsilane based on a total mol % of the difunctional silicon alkoxide.
<8> The cured body according to any one of <5> to <7>, having a pencil hardness of HB or more.
<9> The cured body according to any one of <5> to <8>, having a Vickers hardness of 1 HV or higher.
<10> The cured body according to any one of <5> to <9>, having an ultraviolet absorption edge wavelength of 250 nm or less.
<11> The cured body according to any one of <5> to <10>, having a thickness of 4.8 mm or more.
<12> The cured body according to any one of <5> to <11>, which is used in electric and electronic components.
<13> A method for producing a polysilsesquioxane liquid precursor, the method comprising subjecting a trifunctional silicon alkoxide and a difunctional silicon alkoxide to a hydrolysis reaction and a polycondensation reaction in an aqueous solution without using an organic solvent in the presence of an acid catalyst, with aging during the hydrolysis reaction and the polycondensation reaction.
<14> The method for producing a polysilsesquioxane liquid precursor according to <13>, in which the trifunctional silicon alkoxide is used in an amount of 0.5 mol to 0.99 mol based on 1 mol of a total of silicon alkoxides.
<15> The method for producing a polysilsesquioxane liquid precursor according to <13> or <14>, in which the acid catalyst is used in an amount of more than 0 mol and 0.01 mol or less based on 1 mol of a total of silicon alkoxides.
<16> The method for producing a polysilsesquioxane liquid precursor according to any one of <13> to <15>, in which water is used in an amount of 1.5 mol to 50 mol based on 1 mol of a total of silicon alkoxides.
<17> The method for producing a polysilsesquioxane liquid precursor according to any one of <13> to <16>, in which the trifunctional silicon alkoxide includes 80 mol % or more of methyltrimethoxysilane based on a total mol % of the trifunctional silicon alkoxide.
<18> The method for producing a polysilsesquioxane liquid precursor according to any one of <13> to <17>, in which the difunctional silicon alkoxide includes 80 mol % or more of dimethoxydimethylsilane based on a total mol % of the difunctional silicon alkoxide.
<19> The method for producing a polysilsesquioxane liquid precursor according to any one of <13> to <18>, comprising removing an alcohol generated in the hydrolysis reaction.
<20> A method for producing a cured body, comprising heating and curing a polysilsesquioxane liquid precursor obtained by the method for producing a polysilsesquioxane liquid precursor according to any one of <13> to <19>.

### EXAMPLES

Hereinafter, the present invention will be described with reference to Examples, but the present invention is not limited thereto. Examples 1 to 27, 32, and 36 to 39 are Inventive Examples, and Examples 28 to 31, 33 to 35, and 40 are Comparative Examples.

### Test Example 1

### Example 1

Methyltrimethoxysilane, which is a trifunctional silicon alkoxide, and dimethoxydimethylsilane, which is a difunctional silicon alkoxide, were mixed at a ratio of methyltrimethoxysilane:dimethoxydimethylsilane=0.5:0.5 so that the total molar ratio was 1, and the total amount was 100 mmol.

Dilute hydrochloric acid composed of 0.2 mmol of hydrogen chloride (HCl/silicon ratio was 0.002) and 250 mmol of water (water/silicon ratio was 2.5) was added thereto, followed by stirring in an airtight container at 20° C. for 3 hours. Thereafter, the mixture was left to stand at 80° C. for 24 hours for aging, and hydrolysis and polycondensation were allowed to proceed.

After aging, the container was cooled to room temperature and opened, and the upper-layer solution formed by liquid-liquid phase separation was extracted and removed with a Pasteur pipette.

The lower-layer solution was vacuum-dried at 60° C. for 24 hours to obtain a colorless transparent liquid precursor.

### Examples 2 to 10

Colorless transparent liquid precursors were obtained in the same manner as in Example 1 except that the amounts of methyltrimethoxysilane, dimethoxydimethylsilane, and water used were changed as shown in Table 1.

### <Measurement of Viscosity>

The viscosity of the liquid precursor at 30° C. and 40° C. was measured using an EMS viscometer (“EMS-1000S” manufactured by Kyoto Electronics Manufacturing Co., Ltd.).

The results are shown in Table 1.

### <Measurement of Molar Mass>

The weight average molar mass (weight average molecular weight) Mm and the number average molar mass (number average molecular weight) Mn of the liquid precursor were determined by gel permeation chromatography.

“RID-10A” manufactured by Shimadzu Corporation was used as a detector, “Shodex KF-804L” manufactured by Showa Denko K.K. was used as a column, tetrahydrofuran was used as a solvent, the measurement was performed under conditions of a flow rate of 1.0 ml/min and an injection amount of 20 μl, and a weight average molar mass and a number average molar mass were calculated from a calibration curve using polystyrene having a known molar mass as a standard substance.

The results are shown in Table 1.

### <NMR Measurement>

The ¹H and ²⁹Si NMR spectra of the liquid precursor were measured using “JMN-ECS300” manufactured by JEOL Ltd. and using CDCl₃ as a solvent. The ¹H nuclei and the ²⁹Si nuclei were measured at 300 MHz and 59.6 MHz, respectively.

The fractions (f_{T1}, f_{T2}, f_{T3}, f_{D1}, f_{D2}) of the T-form and the D-form were determined from the ²⁹Si NMR spectrum, and the average number of bridging oxygen atoms <m> was determined from the following formula (2).

$$< m > = ( {f}_{T 1} \times {n}_{T 1} ) + ( {f}_{T 2} \times {n}_{T 2} ) + ( {f}_{T 3} \times {n}_{T 3} ) + ( {f}_{D 1} \times {n}_{D 1} ) + ( {f}_{D 2} \times {n}_{D 2} ) \qquad ( 2 )$$

In the formula (2),
f_{T1} represents a fraction of a T¹ structural unit having one bridging oxygen atom among the structural units derived from the trifunctional silicon alkoxide,
n_{T1} represents 1, which is the number of bridging oxygen atoms in the T¹-form structural unit,
f_{T2} represents a fraction of a T² structural unit having two bridging oxygen among the structural units derived from the trifunctional silicon alkoxide,
n_{T2} represents 2, which is the number of bridging oxygen atoms in the T²-form structural unit,
f_{T3} represents a fraction of a T³ structural unit having three bridging oxygen atoms among the structural units derived from the trifunctional silicon alkoxide,
n_{T3} represents 3, which is the number of bridging oxygen atoms in the T³-form structural unit,
f_{D1} represents a fraction of a D¹ structural unit having one bridging oxygen atom among the structural units derived from the difunctional silicon alkoxide,
n_{D1} represents 1, which is the number of bridging oxygen atoms in the D¹-form structural unit,
f_{D2} represents a fraction of a D² structural unit having two bridging oxygen atoms among the structural units derived from the difunctional silicon alkoxide,
n_{D2} represents 2, which is the number of bridging oxygen atoms in the D²-form structural unit, and

$${f}_{T 1} + {f}_{T 2} + {f}_{T 3} + {f}_{D 1} + {f}_{D 2} = 1 .$$

Then, the proportion of bridging oxygen atoms was determined according to the following formula (1).

$$Proportion of bridging oxygen atoms = < m > / < m {>}_{max} \qquad ( 1 )$$

In the formula (1),
<m>ₘₐₓ represents the maximum average number of bridging oxygen atoms in the complete copolymer when all the structural units in the structural units derived from the trifunctional silicon alkoxide are T³ structural units having three bridging oxygen atoms, and all the structural units in the structural units derived from the difunctional silicon alkoxide are D² structural units having two bridging oxygen atoms.

Subsequently, the residual methoxy group fraction f_{SiOMe} was determined from the 1H NMR spectrum, and the residual silanol group fraction f_{SiOH} was determined according to the following formula (3).

$$Residual silanol group fraction {f}_{SiOH} = 1 - ( < m > / < m {>}_{max} + {f}_{SiOMe} ) \qquad ( 3 )$$

The results are shown in Table 1.

In Examples 2, 4, and 8 to 10, only the maximum average number of bridging oxygen atoms in the complete copolymer <m>ₘₐₓ was described for the structure of the liquid precursor. Only the weight average molar mass Mm and the number average molar mass Mn were measured in Example 4, and the physical properties were not measured in Example 2.

In Table 1, the sum of the fractions (f_{T1}, f_{T2}, f_{T3}, f_{D1}, and f_{D2}) of the structural units of Example 6 and the sum of <m>/<m>ₘₐₓ, f_{SiOMe}, and f_{SiOH} of Example 7 are not 1 due to rounding errors of numerical values.

TABLE 1

| | | | Example 1 | Example 2 | Example 3 | Example 4 | Example 5 |
|---|---|---|---|---|---|---|---|
| Methyltrimethoxysilane | | Molar ratio | 0.5 | 0.5 | 0.5 | 0.6 | 0.6 |
| (trifunctional) | | | | | | | |
| Dimethoxydimethylsilane | | Molar ratio | 0.5 | 0.5 | 0.5 | 0.4 | 0.4 |
| (difunctional) | | | | | | | |
| Hydrogen chloride | | HCl/silicon | 0.002 | 0.002 | 0.002 | 0.002 | 0.002 |
| | | ratio | | | | | |
| Water | | Water/silicon | 2.5 | 3 | 5 | 3 | 5 |
| | | ratio | | | | | |
| Viscosity (30° C.) | | mPa · s | 1660 | — | 725 | — | 9300 |
| Viscosity (40° C.) | | mPa · s | 1020 | — | 385 | — | 3880 |
| Weight average molar | | 10³ g · mol⁻¹ | 19.8 | — | 4.9 | 45.8 | 10.5 |
| mass (Mm) | | | | | | | |
| Number average molar | | 10³ g · mol⁻¹ | 3.2 | — | 2.1 | 3.4 | 2.2 |
| mass (Mn) | | | | | | | |
| Fraction of structural | f_{D1} | — | 0.03 | — | 0.04 | — | 0.02 |
| units | f_{D2} | — | 0.46 | — | 0.44 | — | 0.37 |
| | f_{T1} | — | 0 | — | 0.01 | — | 0.01 |
| | f_{T2} | — | 0.13 | — | 0.20 | — | 0.22 |
| | f_{T3} | — | 0.38 | — | 0.31 | — | 0.38 |

| | | | | | | |
|---|---|---|---|---|---|---|
| <m> | — | 2.35 | — | 2.26 | — | 2.35 |
| <m>ₘₐₓ | — | 2.5 | 2.5 | 2.5 | 2.6 | 2.6 |
| Formula (1): <m>/<m>ₘₐₓ | — | 0.94 | — | 0.90 | — | 0.90 |
| f_{SiOMe} | — | 0.03 | — | 0.03 | — | 0.03 |
| f_{SiOH} | — | 0.03 | — | 0.07 | — | 0.07 |

| | | | Example 6 | Example 7 | Example 8 | Example 9 | Example 10 |
|---|---|---|---|---|---|---|---|
| Methyltrimethoxysilane | | Molar ratio | 0.6 | 0.6 | 0.7 | 0.7 | 0.7 |
| (trifunctional) | | | | | | | |
| Dimethoxydimethylsilane | | Molar ratio | 0.4 | 0.4 | 0.3 | 0.3 | 0.3 |
| (difunctional) | | | | | | | |
| Hydrogen chloride | | HCl/silicon | 0.002 | 0.002 | 0.002 | 0.002 | 0.002 |
| | | ratio | | | | | |
| Water | | Water/silicon | 10 | 20 | 10 | 20 | 30 |
| | | ratio | | | | | |
| Viscosity (30° C.) | | mPa · s | 8140 | 7630 | — | 106000 | 171000 |
| Viscosity (40° C.) | | mPa · s | 2930 | 2470 | — | 23300 | 34000 |
| Weight average molar | | 10³ g · mol⁻¹ | 2.9 | 1.7 | — | 4.9 | 1.8 |
| mass (Mm) | | | | | | | |
| Number average molar | | 10³ g · mol⁻¹ | 1.5 | 1.1 | — | 1.2 | 1.1 |
| mass (Mn) | | | | | | | |
| Fraction of structural | f_{D1} | — | 0.04 | 0.05 | — | — | — |
| units | f_{D2} | — | 0.36 | 0.34 | — | — | — |
| | f_{T1} | — | 0.02 | 0.03 | — | — | — |
| | f_{T2} | — | 0.27 | 0.30 | — | — | — |
| | f_{T3} | — | 0.32 | 0.28 | — | — | — |

| | | | | | | |
|---|---|---|---|---|---|---|
| <m> | — | 2.26 | 2.20 | — | — | — |
| <m>ₘₐₓ | — | 2.6 | 2.6 | 2.7 | 2.7 | 2.7 |
| Formula (1): <m>/<m>ₘₐₓ | — | 0.87 | 0.85 | — | — | — |
| f_{SiOMe} | — | 0.02 | 0.02 | — | — | — |
| f_{SiOH} | — | 0.11 | 0.14 | — | — | — |

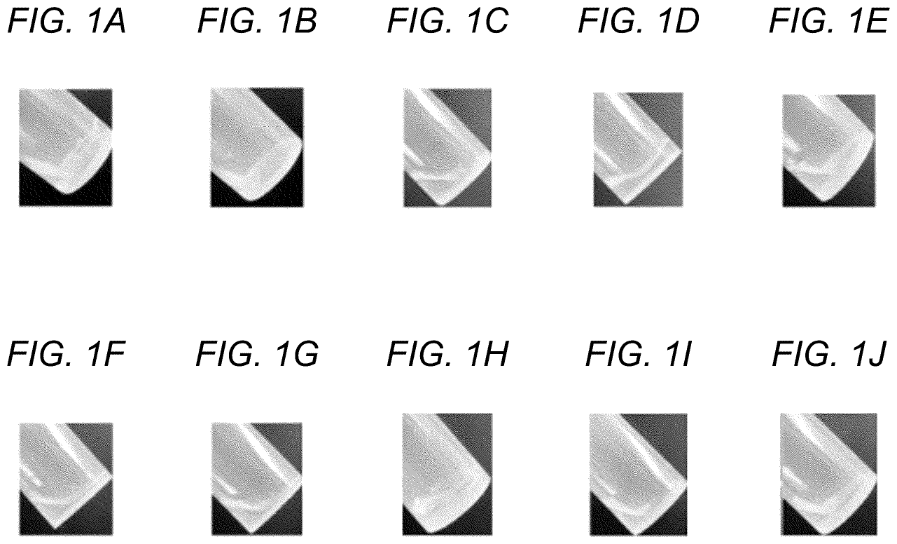

FIGS. 1A to 1J show appearances of the liquid precursors of Examples 1 to 10, respectively.

As shown in FIGS. 1A to 1J, the liquid precursors of Examples 1 to 10 were all obtained as liquids.

### Test Example 2

### Example 11

Methyltrimethoxysilane, which is a trifunctional silicon alkoxide, and dimethoxydimethylsilane, which is a difunctional silicon alkoxide, were mixed at a ratio of methyltrimethoxysilane:dimethoxydimethylsilane=0.8:0.2 so that the total molar ratio was 1, and the total amount was 100 mmol.

Dilute hydrochloric acid composed of 0.02 mmol of hydrogen chloride (HCl/silicon ratio was 0.0002) and 500 mmol of water (water/silicon ratio was 5) was added thereto, followed by stirring in an airtight container at 20° C. for 3 hours. Thereafter, the mixture was left to stand at 80° C. for 24 hours for aging, and hydrolysis and polycondensation were allowed to proceed.

After aging, the container was cooled to room temperature and opened, and the upper-layer solution formed by liquid-liquid phase separation was extracted and removed with a Pasteur pipette.

The lower-layer solution was vacuum-dried at 60° C. for 24 hours to obtain a colorless transparent liquid precursor.

### Examples 12 to 19

Colorless transparent liquid precursors were obtained in the same manner as in Example 11 except that the amounts of methyltrimethoxysilane, dimethoxydimethylsilane, water, and hydrogen chloride used were changed as shown in Table 2.

### <Measurement of Viscosity>

The viscosity of the liquid precursor at 40° C. was measured in the same manner as in Test Example 1. Results are shown in Table 2.

### <Measurement of Molar Mass>

The weight average molar mass and the number average molar mass of the liquid precursors were calculated in the same manner as in Test Example 1. Results are shown in Table 2.

### <NMR Measurement>

In the same manner as in Test Example 1, the fractions (f_{T1}, f_{T2}, f_{T3}, f_{D1}, and f_{D2}) of the T unit and the D unit of the liquid precursors, the average number of bridging oxygen atoms <m>, the maximum average number of bridging oxygen atoms in the complete copolymer <m>ₘₐₓ, the ratio of bridging oxygen atoms <m>/<m>ₘₐₓ, the residual methoxy group fraction f_{SiOMe}, and the residual silanol group fraction f_{SiOH} were determined. The results are shown in Table 2.

In Table 2, the sum of the fractions (f_{T1}, f_{T2}, f_{T3}, f_{D1}, and f_{D2}) of the structural units of Example 12 and the sum of <m>/<m>ₘₐₓ, f_{SiOMe}, and f_{SiOH} of Example 14 are not 1 due to rounding errors of numerical values.

TABLE 2

| | | | Example 11 | Example 12 | Example 13 | Example 14 | Example 15 |
|---|---|---|---|---|---|---|---|
| Methyltrimethoxysilane | | Molar ratio | 0.8 | 0.8 | 0.8 | 0.8 | 0.7 |
| (trifunctional) | | | | | | | |
| Dimethoxydimethylsilane | | Molar ratio | 0.2 | 0.2 | 0.2 | 0.2 | 0.3 |
| (difunctional) | | | | | | | |
| Hydrogen chloride | | HCl/silicon | 0.0002 | 0.0002 | 0.0002 | 0.0002 | 0.0002 |
| | | ratio | | | | | |
| Water | | Water/silicon | 5 | 10 | 20 | 30 | 3 |
| | | ratio | | | | | |
| Viscosity (40° C.) | | mPa · s | 1 × 10⁶ or | 528000 | 38000 | 219000 | Gelation |
| | | | more | | | | |
| Weight average molar mass | | 10³ g · mol⁻¹ | 7.38 | 3.04 | 2.07 | 1.83 | 17.0 |
| (Mm) | | | | | | | |
| Number average molar | | 10³ g · mol⁻¹ | 2.3 | 1.52 | 1.24 | 1.16 | 2.81 |
| mass (Mn) | | | | | | | |
| Fraction of structural | f_{D1} | — | 0.01 | 0.02 | 0.03 | 0.03 | 0.01 |
| units | f_{D2} | — | 0.19 | 0.18 | 0.18 | 0.19 | 0.28 |
| | f_{T1} | — | 0.01 | 0.02 | 0.03 | 0.03 | 0.01 |
| | f_{T2} | — | 0.31 | 0.37 | 0.39 | 0.38 | 0.22 |
| | f_{T3} | — | 0.48 | 0.40 | 0.37 | 0.37 | 0.48 |

| | | | | | | |
|---|---|---|---|---|---|---|
| <m> | — | 2.47 | 2.35 | 2.30 | 2.30 | 2.46 |
| <m>ₘₐₓ | — | 2.8 | 2.8 | 2.8 | 2.8 | 2.7 |
| Formula (1): <m>/m>ₘₐₓ | — | 0.88 | 0.84 | 0.82 | 0.82 | 0.91 |
| f_{SiOMe} | — | 0.02 | 0.02 | 0.02 | 0.01 | 0.03 |
| f_{SiOH} | — | 0.10 | 0.14 | 0.16 | 0.16 | 0.06 |

| | | | Example 16 | Example 17 | Example 18 | Example 19 |
|---|---|---|---|---|---|---|
| Methyltrimethoxysilane | | Molar ratio | 0.7 | 0.7 | 0.7 | 0.7 |
| (trifunctional) | | | | | | |
| Dimethoxydimethylsilane | | Molar ratio | 0.3 | 0.3 | 0.3 | 0.3 |
| (difunctional) | | | | | | |
| Hydrogen chloride | | HCl/silicon | 0.0002 | 0.0002 | 0.0002 | 0.0002 |
| | | ratio | | | | |
| Water | | Water/silicon | 5 | 10 | 20 | 30 |
| | | ratio | | | | |
| Viscosity (40° C.) | | mPa · s | 27400 | 11500 | 7350 | 6490 |
| Weight average molar mass | | 10³ g · mol⁻¹ | 6.17 | 2.29 | 1.61 | 1.41 |
| (Mm) | | | | | | |
| Number average molar | | 10³ g · mol⁻¹ | 2.16 | 1.37 | 1.08 | 0.99 |
| mass (Mn) | | | | | | |
| Fraction of structural | f_{D1} | — | 0.03 | 0.03 | 0.06 | 0.04 |
| units | f_{D2} | — | 0.26 | 0.27 | 0.25 | 0.27 |
| | f_{T1} | — | 0.01 | 0.03 | 0.03 | 0.02 |
| | f_{T2} | — | 0.28 | 0.32 | 0.36 | 0.35 |
| | f_{T3} | — | 0.42 | 0.35 | 0.30 | 0.32 |

| | | | | | |
|---|---|---|---|---|---|
| <m> | — | 2.37 | 2.30 | 2.21 | 2.26 |
| <m>ₘₐₓ | — | 2.7 | 2.7 | 2.7 | 2.7 |
| Formula (1): <m>/<m>ₘₐₓ | — | 0.88 | 0.85 | 0.82 | 0.84 |
| f_{SiOMe} | — | 0.03 | 0.02 | 0.02 | 0.01 |
| f_{SiOH} | — | 0.09 | 0.13 | 0.16 | 0.15 |

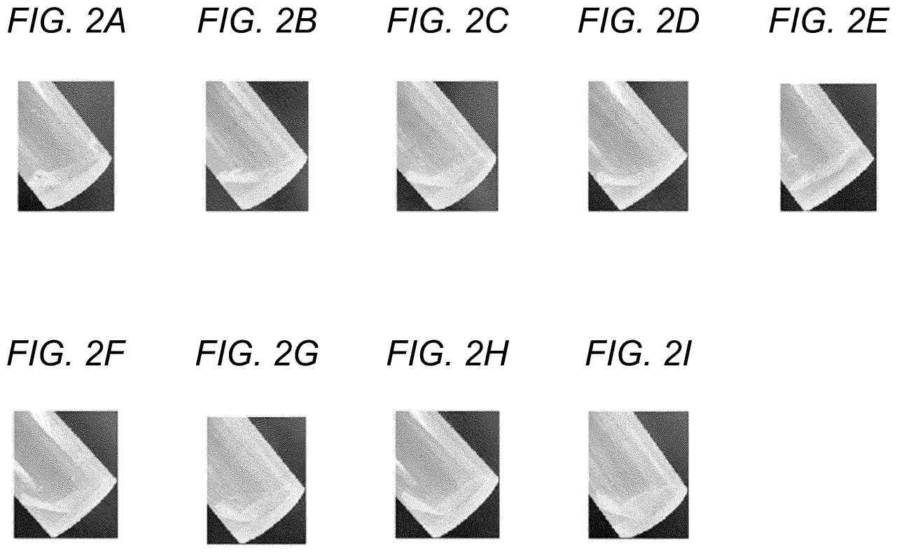

FIGS. 2A to 2I show appearances of liquid precursors in Examples 11 to 19, respectively.

As shown in FIGS. 2A to 2I, the liquid precursors in Examples 11 to 19 were all obtained as liquids.

### Test Example 3

For the liquid precursors in Examples 12 to 14 and Examples 16 to 19 produced in Test Example 2, a change in viscosity over time was checked. Using an EMS viscometer “EMS-1000S” manufactured by Kyoto Electronics Manufacturing Co., Ltd., the viscosity at 40° C. of the liquid precursor immediately after production and the viscosity at 40° C. of the liquid precursor after being held at room temperature (about 20° C. to 30° C.) for a maximum of 60 days in a airtight container were measured, and a viscosity increase rate (%) was determined from the following formula.

$$Viscosity increase rate ( \% ) = ( viscosity after storage at room temperature for 60 days / viscosity immediately after production - 1 ) \times 100$$

The results of the viscosity increase rate are shown in Table 3.

The viscosity of the liquid precursors in Examples 12, 14, and 16 exceeded 1×10⁶ mPa·s before 60 days, and thus, the viscosity increase rate could not be measured.

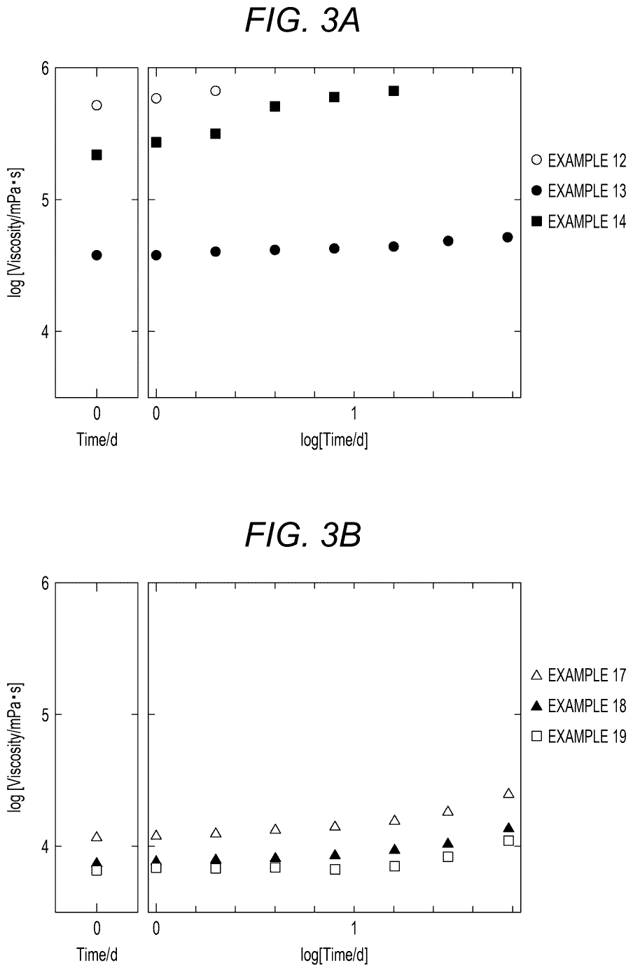

The change of the viscosity of the liquid precursor is shown in FIG. 3 for Examples 12 to 14 and Examples 17 to 19. FIG. 3A shows the results of Examples 12 to 14, and FIG. 3B shows the results of Examples 17 to 19.

TABLE 3

| | | | | | | | | | Viscosity |
|---|---|---|---|---|---|---|---|---|---|
| | | | | | | | | | increase |
| | Viscosity (40° C.)/mPa · s | | | | | | | | rate (%) |
| | | 1 day | 2 days | 4 days | 8 days | 16 days | 30 days | 60 days | after 60 |
| | 0 day | later | later | later | later | later | later | later | days |
| Example | 528000 | 585000 | 673500 | Not | Not | Not | Not | Not | Not |
| 12 | | | | measurable | measurable | measurable | measurable | measurable | measurable |
| Example | 38000 | 39000 | 40300 | 41700 | 42600 | 44500 | 49900 | 52200 | 37 |
| 13 | | | | | | | | | |
| Example | 219000 | 274000 | 324000 | 515000 | 603000 | 666000 | Not | Not | Not |
| 14 | | | | | | | measurable | measurable | measurable |
| Example | 27400 | 31300 | 201000 | Not | Not | Not | Not | Not | Not |
| 16 | | | | measurable | measurable | measurable | measurable | measurable | measurable |
| Example | 11500 | 11800 | 12300 | 13300 | 13900 | 15700 | 18200 | 24500 | 113 |
| 17 | | | | | | | | | |
| Example | 7350 | 7540 | 7730 | 8020 | 8310 | 9190 | 10200 | 13500 | 84 |
| 18 | | | | | | | | | |
| Example | 6490 | 6760 | 6630 | 6640 | 6510 | 6910 | 8180 | 10800 | 66 |
| 19 | | | | | | | | | |

As shown in Table 3 and FIGS. 3A and 3B, the liquid precursors in Examples 12 to 14 and Examples 16 to 19 had a moderate increase in viscosity and were excellent in temporal stability. In particular, it was found that the liquid precursors in Example 13 and Examples 17 to 19 had a small increase in viscosity even after 60 days, and the viscosity was stable for a long period of time.

### Test Example 4

### Example 20

Methyltrimethoxysilane, which is a trifunctional silicon alkoxide, and dimethoxydimethylsilane, which is a difunctional silicon alkoxide, were mixed at a ratio of methyltrimethoxysilane:dimethoxydimethylsilane=0.8:0.2 so that the total molar ratio was 1, and the total amount was 100 mmol.

Dilute hydrochloric acid composed of 0.2 mmol of hydrogen chloride (HCl/silicon ratio was 0.002) and 2000 mmol of water (water/silicon ratio was 20) was added thereto, followed by stirring in an airtight container at 20° C. for 3 hours. Thereafter, the mixture was left to stand at 80° C. for 24 hours for aging, and hydrolysis and polycondensation were allowed to proceed.

After aging, the container was cooled to room temperature and opened, and the upper-layer solution formed by liquid-liquid phase separation was extracted and removed with a Pasteur pipette.

The lower-layer solution was vacuum-dried at 60° C. for 24 hours to obtain a colorless transparent liquid precursor.

### Examples 21 to 24

Colorless transparent liquid precursors were obtained in the same manner as in Example 20 except that the amounts of methyltrimethoxysilane, dimethoxydimethylsilane, water, and hydrogen chloride used were changed as shown in Table 4.

Example 22 is the same as the liquid precursor in Example 13.

### <Measurement of Viscosity>

The viscosity of the liquid precursor at 40° C. was measured in the same manner as in Test Example 1. The results are shown in Table 4.

### <Measurement of Molar Mass>

The weight average molar mass and the number average molar mass of the liquid precursors were calculated in the same manner as in Test Example 1. The results are shown in Table 4.

TABLE 4

| | | Example 20 | Example 21 | Example 22 | Example 23 | Example 24 |
|---|---|---|---|---|---|---|
| Methyltrimethoxysilane | Molar ratio | 0.8 | 0.8 | 0.8 | 0.8 | 0.8 |
| (trifunctional) | | | | | | |
| Dimethoxydimethylsilane | Molar ratio | 0.2 | 0.2 | 0.2 | 0.2 | 0.2 |
| (difunctional) | | | | | | |
| Hydrogen chloride | HCl/silicon ratio | 0.002 | 0.001 | 0.0002 | 0.0001 | 0.00002 |
| Water | Water/silicon ratio | 20 | 20 | 20 | 20 | 20 |
| Viscosity (40° C.) | mPa · s | Gelation | 1 × 10⁶ or | 38000 | 35000 | 30000 |
| | | | more | | | |
| Weight average molar mass | 10³ g · mol⁻¹ | 3.49 | 2.86 | 2.07 | 1.99 | 2.38 |
| (Mm) | | | | | | |
| Number average molar mass | 10³ g · mol⁻¹ | 1.52 | 1.44 | 1.24 | 1.23 | 1.32 |
| (Mn) | | | | | | |

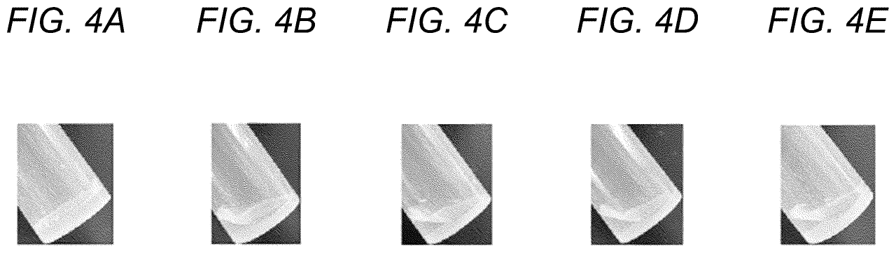

FIGS. 4A to 4E show appearances of liquid precursors in Examples 20 to 24, respectively.

As shown in FIGS. 4A to 4E, the liquid precursors in Examples 20 to 24 were all obtained as liquids.

### Test Example 5

### Example 25

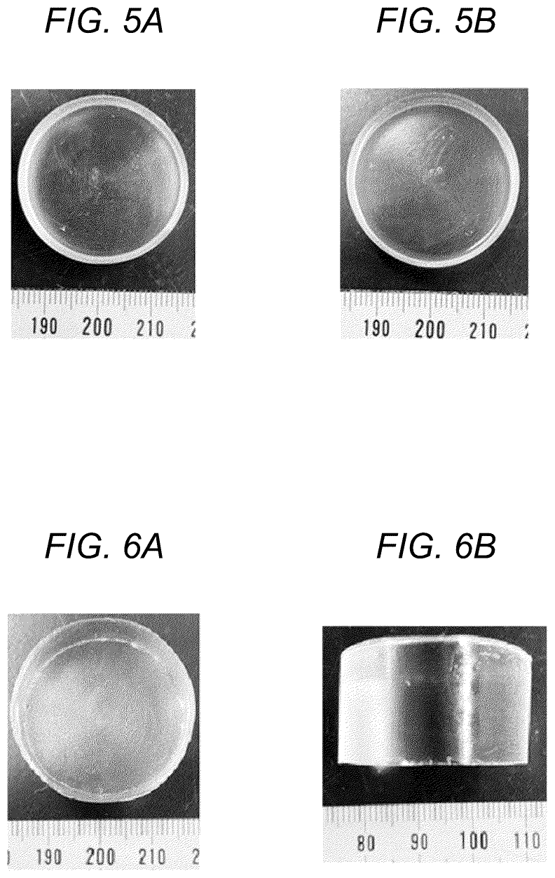

The liquid precursor in Example 13 was heated in a nitrogen atmosphere at 200° C. for 24 hours to obtain a cured body having a thickness of 4.9 mm. FIG. 5A shows the appearance of the obtained cured body (a photograph viewed from above).

### Example 26

The liquid precursor in Example 13 was heated in a nitrogen atmosphere at 200° C. for 12 hours and then at 250° C. for 24 hours to obtain a cured body having a thickness of 5.4 mm. FIG. 5B shows the appearance of the obtained cured body (a photograph viewed from above).

### Example 27

A colorless transparent liquid precursor was obtained in the same manner as in Example 13 except that the total amount of methyltrimethoxysilane as a trifunctional silicon alkoxide and dimethoxydimethylsilane as a difunctional silicon alkoxide was changed to 300 mmol. The fluidity of the liquid precursor was visually comparable to that of Example 13, and therefore, it was determined that the viscosity at 40° C. was comparable to that of Example 13.

The obtained liquid precursor was placed in a mold having a diameter of 30 mm and a depth of 20 mm, and heated in a nitrogen atmosphere at 120° C. for 6 hours, at 180° C. for 6 hours, and then at 250° C. for 24 hours to obtain a cured body having a thickness of 15.6 mm. A top view and a side view of the obtained cured body are shown in FIGS. 6A and 6B, respectively.

### Example 28

Dilute hydrochloric acid composed of 0.02 mmol of hydrogen chloride (HCl/silicon ratio was 0.0002) and 2000 mmol of water (water/silicon ratio was 20) was added to 100 mmol of ethyltrimethoxysilane, which is a trifunctional silicon alkoxide, followed by stirring in an airtight container at 20° C. for 3 hours. Thereafter, the mixture was left to stand at 80° C. for 24 hours for aging, and hydrolysis and polycondensation were allowed to proceed.

After aging, the container was cooled to room temperature and opened, and the upper-layer solution formed by liquid-liquid phase separation was extracted and removed with a Pasteur pipette.

The lower-layer solution was vacuum-dried at 60° C. for 24 hours to obtain a colorless transparent liquid precursor. The viscosity at 40° C. of the liquid precursor was 27300 mPa·s.

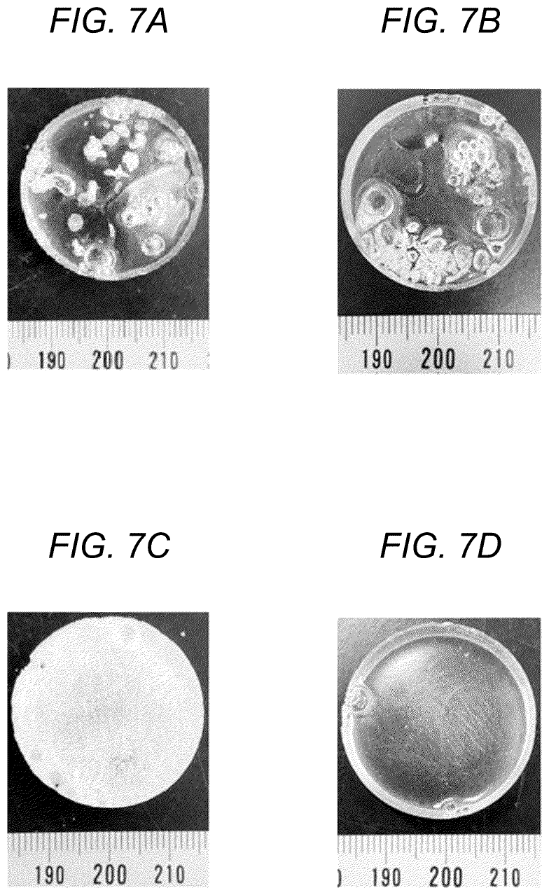

The obtained liquid precursor was heated in a nitrogen atmosphere at 200° C. for 24 hours to obtain a cured body having a thickness of 4.8 mm. FIG. 7A shows the appearance of the obtained cured body (a photograph viewed from above).

### Examples 29 to 31

Cured bodies were obtained in the same manner as in Example 28 except that the heating conditions of the liquid precursor were changed as shown in Table 5. FIGS. 7B to 7D show the appearances of the obtained cured bodies (photographs viewed from above). FIGS. 7B to 7D show cured bodies in Examples 29 to 31, respectively.

### <Measurement of Hardness>

The pencil hardness of the cured body was measured according to a manual scratching method in accordance with the pencil scratch test specified in the former JIS K 5400.

First, a lead tip of a pencil used for a test was held perpendicular to No. 400 abrasive paper placed on a hard flat surface, and the lead tip was polished such that the lead tip was flat and the corners were sharp. The polished lead tip was brought into contact with a surface of a cured body at an angle of 45°, and while the lead tip was pressed against the coating surface as strongly as possible without breaking, the lead tip was pushed away from the tester at a uniform speed for about 1 cm to scratch the coating surface. The pushing speed was about 1 cm/s.

After each scratch, the tip of the pencil lead was polished, and the test was repeated five times using a pencil having the same hardness designation. The hardness designation one grade lower than that at which the coating film was torn or cut in two or more of the five tests was recorded.

As the evaluation criteria, pencil hardness was evaluated, from the hardest to the softest, as 9H, 8H, 7H, 6H, 5H, 4H, 3H, 2H, H, F, HB, B, 2B, 3B, 4B, 5B, and 6B. Results are shown in Table 5.

TABLE 5

| | | Example 25 | Example 26 | Example 27 | Example 28 |
|---|---|---|---|---|---|
| Methyltrimethoxysilane | Molar ratio | 0.8 | 0.8 | 0.8 | — |
| (trifunctional) | | | | | |
| Ethyltrimethoxysilane | Molar ratio | — | — | — | 1 |
| (trifunctional) | | | | | |
| Dimethoxydimethylsilane | Molar ratio | 0.2 | 0.2 | 0.2 | — |
| (difunctional) | | | | | |
| Hydrogen chloride | HCl/silicon | 0.0002 | 0.0002 | 0.0002 | 0.0002 |
| | ratio | | | | |
| Water | Water/silicon | 20 | 20 | 20 | 20 |
| | ratio | | | | |
| Cured body production | — | 200° C., | 200° C., 12 h | 120° C., 6 h | 200° C., |
| conditions (heating | | 24 h | → 250° C., | → 180° C., 6 h | 24 h |
| temperature (° C.)/time | | | 24 h | → 250° C., 24 h | |
| (h)) | | | | | |
| Thickness | — | 4.9 mm | 5.4 mm | 15.6 mm | 4.8 mm |
| Pencil hardness | — | HB | 6H | 6H | B |

| | | Example 29 | Example 30 | Example 31 |
|---|---|---|---|---|
| Methyltrimethoxysilane | Molar ratio | — | — | — |
| (trifunctional) | | | | |
| Ethyltrimethoxysilane | Molar ratio | 1 | 1 | 1 |
| (trifunctional) | | | | |
| Dimethoxydimethylsilane | Molar ratio | — | — | — |
| (difunctional) | | | | |
| Hydrogen chloride | HCl/silicon | 0.0002 | 0.0002 | 0.0002 |
| | ratio | | | |
| Water | Water/silicon | 20 | 20 | 20 |
| | ratio | | | |
| Cured body production | — | 150° C., 12 h | 200° C., 12 h | 150° C., |
| conditions (heating | | → 200° C., | → 250° C., | 24 h |
| temperature (° C.)/time | | 24 h | 24 h | |
| (h)) | | | | |
| Thickness | — | 5.2 mm | 5.4 mm | 5.1 mm |
| Pencil hardness | — | B | — | 5B |

From the results of Table 5 and FIGS. 5 to 7, in Examples 25 to 27, a sufficiently thick transparent cured body having high hardness was obtained. In particular, in Example 27, a cured body having a thickness of 15.6 mm could be formed. In contrast, in Examples 28 and 29, air bubbles were generated, the appearance was poor, and the pencil hardness was low. In Example 30, many cracks were formed on the surface by the heat treatment. In Example 31, the generation of bubbles was inhibited as compared with Examples 28 and 29, but the appearance was partially poor, and the pencil hardness was also low. From these results, it was found that a cured body having high hardness and improved appearance was obtained by using a trifunctional silicon alkoxide and a difunctional silicon alkoxide, which have a methyl group as an organic functional group, in combination.

### Test Example 6

### Example 32

The cured body in Example 26 produced in Test Example 5 was cut into a size of 5 mm in length×5 mm in width×4 mm in height to obtain a sample in Example 32.

### Example 33

The cured body in Example 29 produced in Test Example 5 was cut into a size of 5 mm in length×5 mm in width×4 mm in height to obtain a sample in Example 33.

### Example 34

A commercially available polymethyl methacrylate (PMMA) resin (“ACRYLITE (registered trademark) L001” manufactured by Mitsubishi Chemical Corporation) was prepared.

The PMMA resin was cut into a size of 5 mm in length×5 mm in width×4 mm in height to obtain a sample in Example 34.

### Example 35

A commercially available polyethylene terephthalate (PET) resin (“Sanloid Pet Ace EPG100” manufactured by Sumitomo Bakelite Co., Ltd.) was prepared.

The PET resin was cut into a size of 5 mm in length×5 mm in width×4 mm in height as a sample in Example 35.

### <Uniaxial Loading-Unloading Test>

A compression of 0.5 mm/min was applied to each sample by displacement control, and a stress-strain curve at that time was measured. Subsequently, a stress-strain curve during unloading at 0.5 mm/min was measured.

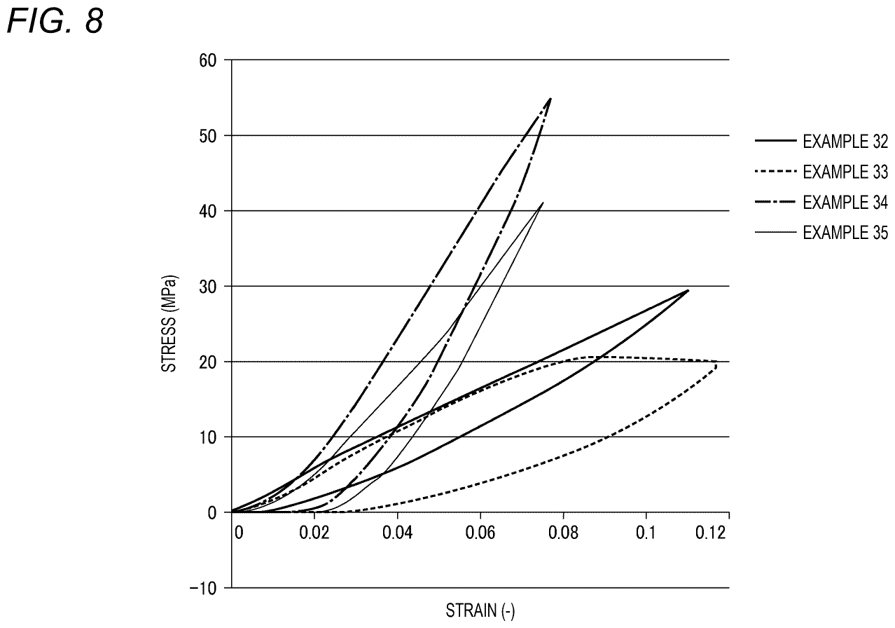

The results are shown in FIG. 8.

From the results of FIG. 8, it was found that in Example 32, when the load was removed, the strain returned to a stage close to an initial state, and the sample exhibited a strong elastic behavior as compared with Examples 34 and 35. The sample in Example 33 yielded under high stress and did not return to the initial state even after unloading.

### Test Example 7

The ultraviolet absorption edge wavelength was determined using the cured body in Example 26 produced in Test Example 5.

### <Measurement of Ultraviolet-Visible Light Absorption Spectrum>

The ultraviolet-visible light absorption spectrum was measured with a spectrophotometer (“U-4100” manufactured by Hitachi High-Technologies Corporation) and normalized by the sample thickness to obtain a spectrum of the light absorption coefficient.

The ultraviolet absorption edge wavelength was determined as an intersection point between an approximate straight line of the spectrum of an ultraviolet absorption edge region and an approximate straight line of a baseline spectrum of the transparent region on the long wavelength side in the obtained light absorption spectrum.

The ultraviolet absorption edge was observed in a vicinity of 195 nm, and based on this observation result, the cured body was found to have high transparency in the ultraviolet region.

### Test Example 8

### Example 36

The liquid precursor of Example 9 (viscosity at 40° C.: 23300 mPa·s) produced in Test Example 1 was heated in a nitrogen atmosphere at 200° C. for 12 hours and then at 250° C. for 24 hours to obtain a cured body.

### Example 37

Methyltrimethoxysilane, which is a trifunctional silicon alkoxide, and dimethoxydimethylsilane, which is a difunctional silicon alkoxide, were mixed at a ratio of methyltrimethoxysilane:dimethoxydimethylsilane=0.75:0.25 so that the total molar ratio was 1, and the total amount was 100 mmol.

Dilute hydrochloric acid composed of 0.2 mmol of hydrogen chloride (HCl/silicon ratio was 0.002) and 3000 mmol of water (water/silicon ratio was 30) was added thereto, followed by stirring in an airtight container at 20° C. for 3 hours. Thereafter, the mixture was left to stand at 80° C. for 24 hours for aging, and hydrolysis and polycondensation were allowed to proceed.

After aging, the container was cooled to room temperature and opened, and the upper-layer solution formed by liquid-liquid phase separation was extracted and removed with a Pasteur pipette.

The lower-layer solution was vacuum-dried at 60° C. for 24 hours to obtain a colorless transparent liquid precursor. The viscosity at 40° C. of the liquid precursor was 50400 mPa·s.

The obtained liquid precursor was heated in a nitrogen atmosphere at 200° C. for 12 hours and then at 250° C. for 24 hours to obtain a cured body.

### Example 38

The cured body in Example 26 produced in Test Example 5 was used.

### Example 39

A colorless transparent liquid precursor was obtained in the same manner as in Example 37 except that the amounts of methyltrimethoxysilane, dimethoxydimethylsilane, hydrogen chloride, and water used were changed as shown in Table 6. The viscosity of the liquid precursor at 40° C. was 1×10⁶ mPa·s or more.

The obtained liquid precursor was heated in a nitrogen atmosphere at 150° C. for 12 hours and then at 250° C. for 24 hours to obtain a cured body.

### Example 40

The cured body in Example 29 produced in Test Example 5 was used.

### <Measurement of Hardness>

The Vickers hardness of the cured body was measured in accordance with JIS R 1610-2003. The results are shown in Table 6.

TABLE 6

| | | Example 36 | Example 37 | Example 38 | Example 39 | Example 40 |
|---|---|---|---|---|---|---|
| Methyltrimethoxysilane | Molar ratio | 0.7 | 0.75 | 0.8 | 0.85 | — |
| (trifunctional) | | | | | | |
| Ethyltrimethoxysilane | Molar ratio | — | — | — | — | 1 |
| (trifunctional) | | | | | | |
| Dimethoxydimethylsilane | Molar ratio | 0.3 | 0.25 | 0.2 | 0.15 | — |
| (difunctional) | | | | | | |
| Hydrogen chloride | HCl/silicon | 0.002 | 0.002 | 0.0002 | 0.0002 | 0.0002 |
| | ratio | | | | | |
| Water | Water/silicon | 20 | 30 | 20 | 20 | 20 |
| | ratio | | | | | |
| Indentation load (gf) | — | 50 | 50 | 50 | 50 | 25 |
| Vickers hardness HV | — | 4.1 | 5.1 | Measurement | Measurement | 2.8 |
| | | | | cannot be | cannot be | |
| | | | | performed because | performed because | |
| | | | | indentation after | indentation after | |
| | | | | unloading cannot | unloading cannot | |
| | | | | be seen | be seen | |

From the results of Table 6, it was found that all of Examples 36 to 39 had a Vickers hardness of 4 or more, and in Examples 38 and 39 in which the proportion of methyltrimethoxysilane to the total silicon alkoxides was 0.8 or more, elastic recovery occurred to such an extent that indentation observation could not be performed. In contrast, in Example 40, the Vickers hardness was as low as 2.8, and the hardness could not be maintained.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-138037) filed on Aug. 28, 2023, the contents of which are incorporated herein by reference.

What is claimed is:

1. A polysilsesquioxane liquid precursor comprising a copolymer of a trifunctional silicon alkoxide and a difunctional silicon alkoxide, wherein a residual silanol group fraction f_{SiOH} in the copolymer is 0.02 to 0.3.

2. The polysilsesquioxane liquid precursor according to claim 1, having a viscosity at 40° C. of 1×10⁶ mPa·s or less.

3. The polysilsesquioxane liquid precursor according to claim 1, wherein the trifunctional silicon alkoxide comprises 80 mol % or more of methyltrimethoxysilane based on a total mol % of the trifunctional silicon alkoxide.

4. The polysilsesquioxane liquid precursor according to claim 1, wherein the difunctional silicon alkoxide comprises 80 mol % or more of dimethoxydimethylsilane based on a total mol % of the difunctional silicon alkoxide.

5. A cured body of a copolymer of a trifunctional silicon alkoxide and a difunctional silicon alkoxide, wherein a residual silanol group fraction f_{SiOH} in the copolymer is 0.02 to 0.3.

6. The cured body according to claim 5, wherein the trifunctional silicon alkoxide comprises 80 mol % or more of methyltrimethoxysilane based on a total mol % of the trifunctional silicon alkoxide.

7. The cured body according to claim 5, wherein the difunctional silicon alkoxide comprises 80 mol % or more of dimethoxydimethylsilane based on a total mol % of the difunctional silicon alkoxide.

8. The cured body according to claim 5, having a pencil hardness of HB or more.

9. The cured body according to claim 5, having a Vickers hardness of 1 HV or higher.

10. The cured body according to claim 5, having an ultraviolet absorption edge wavelength of 250 nm or less.

11. The cured body according to claim 5, having a thickness of 4.8 mm or more.

12. The cured body according to claim 5, which is used in electric and electronic components.

13. A method for producing a polysilsesquioxane liquid precursor, the method comprising subjecting a trifunctional silicon alkoxide and a difunctional silicon alkoxide to a hydrolysis reaction and a polycondensation reaction in an aqueous solution without using an organic solvent in the presence of an acid catalyst, with aging during the hydrolysis reaction and the polycondensation reaction.

14. The method for producing a polysilsesquioxane liquid precursor according to claim 13, wherein the trifunctional silicon alkoxide is used in an amount of 0.5 mol to 0.99 mol based on 1 mol of a total of silicon alkoxides.

15. The method for producing a polysilsesquioxane liquid precursor according to claim 13, wherein the acid catalyst is used in an amount of more than 0 mol and 0.01 mol or less based on 1 mol of a total of silicon alkoxides.

16. The method for producing a polysilsesquioxane liquid precursor according to claim 13, wherein water is used in an amount of 1.5 mol to 50 mol based on 1 mol of a total of silicon alkoxides.

17. The method for producing a polysilsesquioxane liquid precursor according to claim 13, wherein the trifunctional silicon alkoxide comprises 80 mol % or more of methyltrimethoxysilane based on a total mol % of the trifunctional silicon alkoxide.

18. The method for producing a polysilsesquioxane liquid precursor according to claim 13, wherein the difunctional silicon alkoxide comprises 80 mol % or more of dimethoxydimethylsilane based on a total mol % of the difunctional silicon alkoxide.

19. The method for producing a polysilsesquioxane liquid precursor according to claim 13, comprising removing an alcohol generated in the hydrolysis reaction.

20. A method for producing a cured body, comprising heating and curing a polysilsesquioxane liquid precursor obtained by the method for producing a polysilsesquioxane liquid precursor according to claim 13.
